(19) United States
(12) Patent Application Publication
(10) Pub. No.: US 2001/0012993 A1
(43) Pub. Date: Aug. 9, 2001

(54) Coding method facilitating the reproduction as sound of digitized speech signals transmitted to a user terminal during a telephone call set up by transmitting packets, and equipment implementing the method

(76) Inventors: Luc Attimont, Saint Germain En Laye (FR); Pierre Bonnard, Suresnes (FR)

Correspondence Address: SUGHRUE, MION, ZINN, MACPEAK & SEAS, PLLC, Suite 800, 2100 Pennsylvania Avenue, N.W., Washington, DC, 20037-3213, US

(21) Appl. No.: 09/774,571

(22) Filed: Feb. 1, 2001

(30) Foreign Application Priority Data
Feb. 3, 2000 (FR) 00 01 348

(51) Int. Cl. G10L 19/00

(52) U.S. Cl. 704/200.1

(57) ABSTRACT

In a method of coding speech signals transmitted to a user terminal during a VOIP telephone call set up via a packet transmission network the speech signals are conventionally divided into a succession of segments of the same duration by coders of the terminals before they are coded and transmitted in the form of packets and are reproduced from the packets received, eliminating any packet received twice and using a dissimulation algorithm for segments corresponding to missing packets. The method carries out an analysis during coding to identify any segment that is likely not to be able to be replaced by the dissimulation algorithm if the corresponding packet is missing. Any packet corresponding to a segment analyzed as likely not to be able to be replaced is transmitted twice by the sending terminal.

The invention relates to a coding method intended to facilitate the reproduction as sound of digitized speech signals transmitted to a user terminal during a telephone call, in particular a VOIP (Voice Over Internet Protocol) telephone call, i.e. a call set up with another user terminal and via a packet transmission network, for example the Internet, in a telecommunications system using the Internet Protocol (IP) or an equivalent protocol. It also relates to telecommunications equipment and more particularly coders and user terminals provided with coding means which are adapted to enable use of the coding method referred to above.

### BACKGROUND OF THE INVENTION

As is known in the art, setting up a telephone call between users via user terminals interconnected by a packet transmission network involves regularly transmitting packets corresponding to the digitally coded speech signals that relate to the set up call, to enable the destination terminal to reproduce as sound speech signals that it receives in this way with the highest possible fidelity.

It is not always possible to achieve regular transmission, in particular when long data packets are interleaved with packets used for the speech signals of the call. As is also known in the art, packets containing digitally coded speech signals sent by a user terminal can reach the destination user terminal in a order different from that in which they were sent. Some packets can also be received too late to be used, or even not received at all. This being the case, reproducing as sound coded speech signals received by a terminal in the form of packets can make one or more portions of the initially-coded speech unintelligible.

There are methods of eliminating errors in reproducing encoded sound signals, in particular speech signals, transmitted in the form of packets to a destination terminal when the errors are the consequence of variable transmission time-delays affecting packets sent successively by a sending terminal, provided the time-delays remain below a maximum time-delay threshold value. In particular, it is known in the art to provide a terminal transcoding interface including a buffer register for storing digitized speech signals received in the form of packets, sized and adapted to store a sufficient number of packets to enable the signals to be reproduced in the initial order in which the packets were sent and with a reproduction timing rate that corresponds to the timing rate at which the speech was initially produced.

There are also methods of eliminating errors in reproducing coded sound signals and in particular speech signals which are the consequence of the absence of a received packet at the time it should be used for sound reproduction. These methods in particular repeat the sound signal sample transmitted by the preceding packet, by substituting it for the sample corresponding to the missing packet, or by speech interpolation using samples relating to the preceding and/or subsequent packet(s). It is relatively easy to conceal the absence of a packet of coded speech signals if the data in the packet corresponds to a relatively uniform part of a sound signal, for example a sound corresponding to a vowel or a labial consonant. The same cannot be said when the coded speech signals in a missing packet correspond to a part of the sound signal in which the signal varies quickly and/or unpredictably, as is the case with a plosive, for example one corresponding to the sound “t” or “k”. The sound reproduction of the speech signals may then not be faithful and the speech reproduced can be difficult to understand, both when samples corresponding to lost packets are replaced with samples from preceding packets and when samples obtained by interpolation are substituted for the samples that ought to have been transmitted by the missing packets.

It is possible to eliminate or at least greatly to reduce the risk of loss of packets and the resulting inconvenience by transmitting twice over each speech signal packet produced by a terminal in the context of a telephone call operating under conditions which cannot ensure that all packets are transmitted in such a way that they are certain to be recoverable by the destination terminal. However, that method has the drawback of doubling the bandwidth needed to transmit speech signal packets from one user terminal to another in the context of a VOIP telephone call.

### OBJECTS AND SUMMARY OF THE INVENTION

The invention therefore proposes a coding method to facilitate the reproduction as sound of digitized speech signals transmitted to a user in a telecommunications system during a VOIP telephone call set up in real time between the user terminals via the Internet or some other packet transmission network using an equivalent technique in the context of an equivalent protocol, the speech signals picked up by a terminal being coded digitally in accordance with a particular coding protocol which divides them into a succession of time segments of the same duration before converting them into the form of packets which are transmitted via the transmission network to a destination terminal in which the packets are decoded using a decoding protocol complementary to the particular coding protocol to enable the speech signals to be reproduced from reproduced signal segments, eliminating any packets transmitted twice and using a dissimulation algorithm for signal segments corresponding to missing packets.

The method is more particularly intended to eliminate or at least greatly to reduce the risk of loss of meaningful speech signal packets and the resulting inconvenience, achieved at the cost of minimal modification to the user terminals and with no significant increase in transmission bandwidth.

According to a feature of the invention, segments of a succession being coded for transmission in the form of packets are analyzed to determine whether any segment is critical, i.e. likely not to be replaced effectively by a dissimulation algorithm in the destination terminal if the corresponding packet is missing, and/or whether it is to be considered as replaceable by a dissimulation algorithm in the destination terminal under the same conditions.

According to the invention, packets are duplicated for each critical segment in order to enable the sending terminal to transmit critical segments twice.

According to the invention, replaceable packets are suppressed intelligently in the sending terminal in a succession of packets relating to transmitted speech signal segments in order to control the packet transmission bandwidth.

According to the invention, the sending terminal maintains a constant transmit output bandwidth in the event of duplication of critical packets, i.e. packets corresponding to critical segments, for double transmission by intelligently suppressing packets corresponding to replaceable segments and substituting packets resulting from duplication for said replaceable packets prior to transmission.

According to the invention, any critical packet which corresponds to a signal segment having an estimated error value relative to at least the immediately preceding segment which is greater than an estimated error threshold value is duplicated and said error values are determined from predefined characteristics taken into account for the signal segments when they are coded.

According to the invention, an indication of the rate of loss of packets provided by the destination terminal is taken into account in the process of choosing packets to be duplicated in a sending terminal.

The invention also provides telecommunications equipment, in particular coders and user terminals, provided with individual or common coding means adapted to be connected to a packet exchange network and to communicate via the network with compatible equipment by means of packets of digitized sound signals, in particular speech signals, produced in the context of a VOIP telephone call, which equipment includes software means and/or hardware means for implementing the above coding method.

### BRIEF DESCRIPTION OF THE DRAWING

The invention, its features and its advantages are explained in the following description, which is given with reference to the figures listed below.

FIG. 1 is a block diagram relating to a communications system constructed around a network enabling the exchange of information and in particular the exchange of speech signals in the form of digital or digitized signal packets between user terminals and more particularly enabling implementation of the method according to the invention.

FIG. 2 is a block diagram relating to an example combining the various protocols involved in a VOIP call and in particular a call using the method according to the invention.

### MORE DETAILED DESCRIPTION

The coding method according to the invention is more particularly intended to be used in the case of a VOIP call set up in accordance with the Internet Protocol or an equivalent protocol from a user terminal 1, 1′ or 2 and via a communications network 3 transmitting information in the form of digital or digitized signal packets. The network can be the Internet or a network, for example a private network, using the Internet Protocol (IP) or a protocol which can be globally considered functionally equivalent to the Internet Protocol in that it is designed to provide the same kind of functions with at least approximately equivalent resources. This is known in the art.

The user terminals 1, 1′, 2 can be of various kinds, with the common feature that they can send or receive digitized speech signals in the form of packets. They are, for example, individual dedicated voice-data telecommunications devices 1 and 1′, such as terminals routinely referred to as “screenphones”, or specially equipped personal computers. The equipment is possibly common or shared, as symbolized here by the terminal 2, and intended to serve a plurality of voice terminals, for example a plurality of analogue or digital telephones, which it connects to a packet-switched voice-data transmission network.

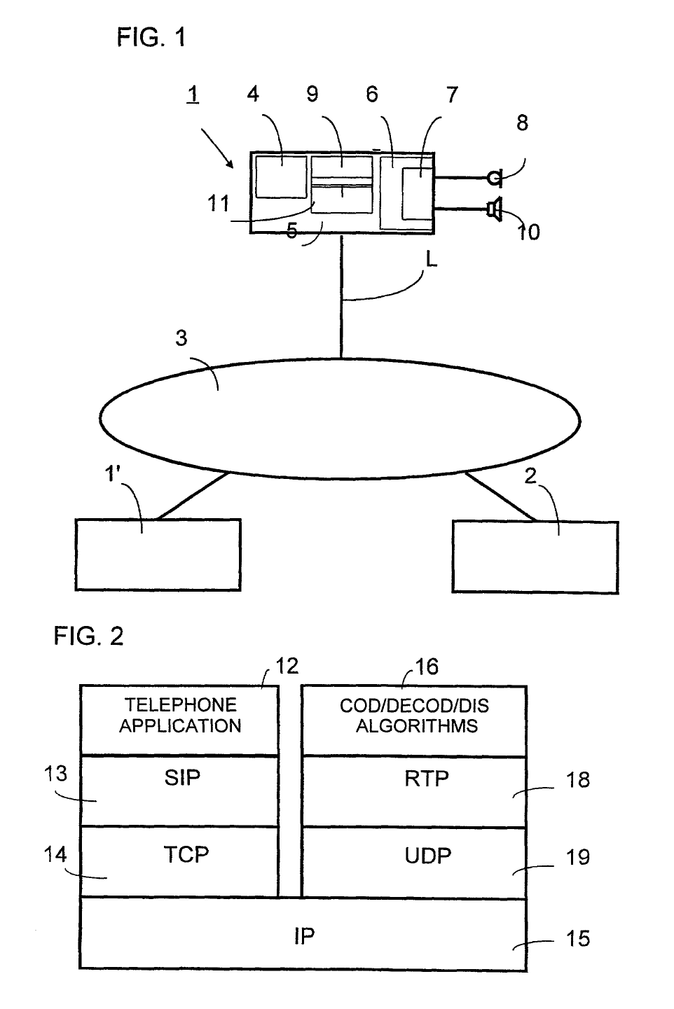

FIG. 1 is a diagram of the structure of one example of an individual terminal 1 which is connected to a communications network 3 by a telephone line L. The connection is effected through an Internet Service Provider (ISP) gateway, for example. The telephone line then terminates at a local telephone exchange which serves the gateway, as is conventional in the case of a terminal connected to the Internet. The line L can equally be a direct line in the case of a terminal connected directly to a packet transmission network.

The terminal 1 conventionally includes programmed control logic 4. It also includes a telecommunications interface 5 which enables a call to be set up with another terminal via the network 3 to exchange digital data and/or digitized signals between the terminals. When the line L is an analogue telephone line, the data and/or signals are exchanged via a modem, not shown, which is connected in series with the line.

The terminal 1 includes a man-machine interface 6 including audio means 7 for processing sound signals, in particular speech signals, picked up by a microphone 8 associated with the terminal, in order to transmit them via the telephone line L after coding them and converting them into the form of packets in a coder/decoder 9. The audio means also reproduce digitized sound signals, in particular digitized speech signals, which reach the coder/decoder 9 over the line L in the form of packets addressed to the user of terminal 1 as sound, for example by means of a loudspeaker 10. Packets from the telephone line L are routed inside the terminal 1 in order to orient the decoded speech signals to the audio means 7 and the data to means, not shown, provided to enable the data to be used. At least some of the data is used in the context of a telephone application using the man-machine interface 6, for example to dial, set up a call and clear down a call.

A set 11 of signal packet send and receive buffers provides the interface between the terminal 1 and the line L. It enables the packets of signals obtained from the speech signals and sounds picked up by the microphone 8 of the terminal to be stored briefly before transmission, once they have been converted into the form of packets after being digitized and usually compressed by means of the coder-decoder module 9. They also store temporarily the last packets transmitted to the terminal 1 via the line L before they are exploited by the coder/decoder module 9 to reproduce the sound signals to which they correspond.

The terminal 1 has appropriate operating and communications programs, for example a browser which it uses to send requests, usually HTTP requests, to communicate with other individual or shared terminals 1′ or 2 which it accesses via the network 3. More particularly, the terminal 1 must have respective sets of call control protocols for packets and telephone signals, for data and data packets, and for transmitting the various packets via the telephone line L in the chosen example. It is assumed here that the system is made up of two protocol stacks placed on top of a layer 15 corresponding to the Internet Protocol IP.

Telephone application monitoring is effected at the level of an application layer 12 which in this example takes charge of the man-machine interface of the terminal equipment. It is used to process telephone operation requests intended to be transmitted from the terminal via the communications network by means of packets.

Requests emanating from the application layer 12 are processed in a transport layer combining a telephone protocol 13 and a protocol 14 for transfer to the IP layer. The protocols 13 and 14 are a standard telephone SIP (Session Initiation Protocol) and a standard TCP (Transmission Control Protocol) or UDP (User Datagram Protocol), for example.

The speech coder/decoder 9 uses a conventional compressive coding/decoding algorithm, for example, such as a standard G723, G729 algorithm, or a non-compressive algorithm, for example the G711 algorithm. The coding/decoding (COD/DECOD) algorithm 16 (FIG. 2) is used to produce digitized speech signal packets from speech signals picked up by the microphone 8 of the terminal in the context of a telephone call and to reproduce signals and in particular voice signals from packets transmitted to the terminal via the line L as sound. As is known in the art, in order to comply with constraints relating to a call set up in real time, the speech signals picked up are periodically sampled and coded in the form of packets before each is transmitted within a planned maximum time-delay.

The packets of digitized speech signals obtained are processed in a transport layer combining the two standard protocols) (Real Time Protocol RTP and User Datagram Protocol UDP), respectively denoted 18 and 19 in the figure. The UDP defines the packet output port which constitutes the coder/decoder 9 in terminal 1 and the arrival port which constitutes the coder/decoder in terminal 1′ for packets of speech signals transmitted from terminal 1 via the line L, for example. The RTP provides functions needed for transporting speech signals and in particular control mechanisms and elements necessary for real time control.

In the example described below, the method according to the invention is applied more particularly to the coding algorithm COD used in the coder/decoder 9 of a terminal and at the level of the RTP stack. As indicated above, the aim is to facilitate reproducing digitized speech signals transmitted by packets during a call set up in real time between two terminals as sound, based on the observation that the loss of some packets transmitted successively from one user terminal to another has greater consequences in terms of sound reproduction than the loss of some others. As already indicated, digitized speech signals which have been transmitted in the form of packets to a destination terminal are conventionally reproduced as sound using various techniques to dissimulate the loss of packets if it is not possible to reproduce a packet directly. To alleviate the absence of a packet, i.e. a sound signal segment, in the sequence of respective successive segments transmitted in the form of a series of packets, a replacement sound segment is substituted for a segment corresponding to a packet of a sequence that is missing. The reproduced sound obtained is generally of good quality if the sounds corresponding to the speech transmitted vary regularly and in a largely predictable manner, but can be much less satisfactory if the missing segments correspond to fast or sudden variations in sound, in particular if the speech contains plosives such as “t”, “k” and “p”. These sound reproduction problems can be predicted at the sending terminal, which uses the coding algorithm COD and has a dissimulation algorithm DIS associated with the algorithm DECOD for decoding the digitized speech signals that are transmitted to it by packets in the context of a call that has been set up.

In accordance with the invention, a terminal therefore analyses the speech signals that it codes by means of an algorithm to send them in the form of packets to another terminal so that it can use its coder to mark any segment of digitized speech signals, referred to herein as critical, that is likely not to be effectively replaced by a dissimulation algorithm DIS in the destination terminal, to which the speech signal segments are sent in the form of a succession of packets, should the corresponding packet be missing from the series of packets received at the time it should be reproduced.

To this end, the sending terminal determines an estimated error value Ee that is permissible for one signal segment relative to the preceding one, for example, and duplicates the packet corresponding to the segment subject to estimation if that value is beyond a threshold value in order to facilitate maintaining the quality of service otherwise obtained on reproducing the segments in the form of sound. The estimated error value Ee allows for various characteristics of the successive speech signals from one packet or from one frame to another. For example, if the coding protocol employed is a standard Code Excited Linear Prediction (CELP) protocol, such as G729, G723.1 or GSM FR, it is possible to re-use the coding parameters and in particular the long-term prediction filter coefficients, short-term filtering and residual error energy between two frames to obtain an estimated error value Ee.

The invention analyses the segments during coding for transmission in the form of packets in order to determine which segments are critical, i.e. which segments that may not be replaced effectively by a dissimulation algorithm in the destination terminal if the corresponding packet is missing. The segments are also analyzed during coding to find if there are any segments that can be considered as replaceable by a dissimulation algorithm in the destination terminal under the same conditions, i.e. if the corresponding packet is missing.

To facilitate the reproduction as sound of digitized speech signals transmitted in the form of packets to a destination terminal, as soon as there is a risk of unacceptable loss or delay of packets the critical segments are duplicated in the sending terminal and any critical packet, i.e. any packet corresponding to a critical segment, is transmitted twice to the destination terminal.

When an estimated error value Ee is determined, the sending terminal applies intelligent duplication and double transmission to any packet corresponding to a signal segment for which the estimated error value is beyond the predetermined threshold value.

It is therefore possible to reduce the risk of a destination terminal not receiving in time critical packets corresponding to speech signal segments that it may not be possible to replace effectively using the dissimulation algorithm of the destination terminal. Receiving duplicated packets is of no consequence in the destination terminal, since RTP conventionally eliminates duplicates of packets already received. This is known in the art

The selection of packets to be duplicated at the sending terminal can take various factors of choice into account. If the destination terminal counts packets that have not reached it, based on information contained in the headers of the packets that it has received, and transmits information relating to such counting in the context of a VOIP telephone call in progress by means of RTCP messages that it sends back to the terminal sending the packets, intelligent duplication can in particular allow for the number of packets not received or the rate at which packets are failing to be received.

The decision function relating to the selection of packets to be duplicated in the sending terminal also takes into account the instantaneous transmission bit rate, the average transmission bit rate and/or the rate of instability or “jitter”, in addition to any indications of lost packets received from the destination terminal. A terminal communicating with another terminal can also transmit information identifying the missing packet dissimulation algorithm DIS it is using. This enables each terminal to allow for the characteristics of the dissimulation algorithm DIS used on reception by the terminal with which it is communicating when it determines which packets to duplicate before sending.

The invention eliminates some packets during coding if it is necessary to transmit duplicate packets and the sending terminal output bandwidth is all in use. Intelligent elimination is possible because there are packets which the dissimulation algorithm of the destination terminal can replace effectively on reception. It is therefore possible to substitute packets whose transmission is judged to be necessary for packets analyzed by the sending terminal as being replaceable by the destination terminal. This substitution is applied to packets which result from intelligent duplication under the conditions indicated above.

The destination terminal is then obliged to reconstitute the initial succession of speech signal segments used to constitute the succession of packets that it has received by re-establishing the packets received in the initially fixed order indicated by their respective headers, using the dissimulation algorithm to replace missing packets and eliminating any duplicated packet that has already been received. As indicated above, in one embodiment of the method according to the invention the destination terminal also counts packets received and packets not received based on information that it obtains by processing data contained in the headers of the packets received.

The coding method in accordance with the invention can be implemented in a user terminal, for example in the terminal 1 shown in FIG. 1, by modifying the software and possibly hardware resources that the coding algorithm COD and the RTP layer which includes the coders and/or user terminals use to code sound signals, in particular speech signals, into the form of packets in the terminal.

1. A coding method to facilitate the reproduction as sound of digitized speech signals transmitted to a user in a telecommunications system during a VOIP telephone call between the user terminals via a packet transmission network, in particular the Internet, the speech signals picked up by a terminal being coded digitally in accordance with a coding protocol which divides them temporally into a succession of segments of the same duration before converting them segment by segment into the form of packets which are transmitted via the transmission network to a destination terminal in which the packets are decoded using a decoding protocol complementary to the coding protocol to enable reproduction of the speech signals from reproduced signal segments, eliminating any packets transmitted twice and using a dissimulation algorithm for signal segments corresponding to missing packets, wherein segments of a succession being coded for transmission in the form of packets are analyzed to determine whether any segment is critical, i.e. likely not to be replaced effectively by a dissimulation algorithm in the destination terminal if the corresponding packet is missing, and/or whether it is to be considered as replaceable by a dissimulation algorithm in the destination terminal under the same conditions.

2. A coding method according to claim 1 in which packets are duplicated for each critical segment in order to enable the sending terminal to transmit critical segments twice.

3. A coding method according to claim 1, wherein replaceable packets are suppressed in the sending terminal in a succession of packets relating to transmitted speech signal segments in order to control the packet transmission bandwidth.

4. A method according to claim 3, wherein the sending terminal maintains a constant transmit output bandwidth in the event of duplication of critical packets for double transmission by suppressing replaceable packets and substituting packets resulting from duplication for said replaceable packets prior to transmission.

5. A method according to claim 2, wherein any critical packet which corresponds to a signal segment having an estimated error value relative to at least the immediately preceding segment which is greater than an estimated error threshold value is duplicated and said error values are determined from predefined characteristics taken into account for the signal segments when they are coded.

6. A method according to claim 2, wherein an indication of the rate of loss of packets provided by the destination terminal is taken into account in the process of choosing packets to be duplicated in a sending terminal.

7. Telecommunications equipment, in particular a coder or a user terminal, provided with individual or common coding means adapted to be connected to a packet exchange network and to communicate via the network with compatible equipment by means of packets of digitized sound signals, in particular speech signals, produced in the context of a VOIP telephone call, said equipment having software and/or hardware means for digitally coding sound signals, in particular speech signals, that it must send in accordance with a particular protocol which temporally divides said signals into a succession of segments of the same duration after they are converted into the form of packets and before they are sent and for reproducing as sound segments of digitized sound signals which are sent to it in the form of packets, eliminating any packets received twice and using a dissimulation algorithm for signal segments corresponding to any missing packets in a succession of received packets, the equipment including software means and hardware means for implementing the coding method according to claim 1.
